(19) United States
(12) Patent Application Publication
(10) Pub. No.: US 2019/0041309 A1
(43) Pub. Date: Feb. 7, 2019

(54) METHOD AND APPARATUS FOR CONTROLLING A MECHANICAL TESTER

(71) Applicant: PHOENIX FIRST RESPONSE, LLC, Glassport, PA (US)

(72) Inventor: Scot D. Abbott, Pittsburgh, PA (US)

(21) Appl. No.: 16/051,118

(22) Filed: Jul. 31, 2018

Related U.S. Application Data
(60) Provisional application No. 62/539,839, filed on Aug. 1, 2017.

(51) Int. Cl. G01N 3/06; G01N 3/08

(52) U.S. Cl. CPC G01N 3/066; G01N 3/08; G01N 2203/0208; G01N 2203/0682; G01N 2203/0688; G01N 2203/0016; G01N 2203/0212

(57) ABSTRACT

A method of controlling a mechanical testing instrument includes estimating a young's modulus, and applying force during a first time interval then comparing distance measured to expected distance; predicting a distance based on a first slope applying displacement distance and recalculating the slope; providing a corrected force applied for the proper displacement based on measured modulus and correction factor and adjusting into time and distance coherence; applying a force versus time regime interval and predict deformation at the end of the second interval measuring true deformation distance after the next interval; calculating the ‘true’ slope’ based on the extrapolated actual slope; calculating a slope to apply for desired distance; and repeating measurement and correction steps, using the actual slope as the prediction basis. A system for carrying out the method is also disclosed using a data acquisition board.

### CROSS REFERENCE TO RELATED APPLICATIONS

This application claims the benefit of U.S. Provisional Patent Application Ser. No. 62/539,839 filed Aug. 1, 2017, entitled “METHOD AND APPARATUS FOR CONTROLLING A MECHANICAL TESTER”, which is hereby incorporated by reference.

### BACKGROUND OF THE INVENTION

The application generally relates to a method and apparatus for controlling a mechanical tester. The application relates more specifically to controlling a mechanical tester with spreadsheet-based control algorithms and data acquisition system.

In many systems control is a sophisticated problem to which a number of strategies have been applied. Control strategies are widely used in industrial applications and general process control, including motor control in materials testers. The most common controllers are embodiments of proportional-integral-derivative (PID) control strategy. PID controllers may function for processes having constant set points, but such controllers require significant heuristic tuning experimentation for them to perform their control function in a suitable manner. Such controllers may include auto-tune protocols to try to minimize the arduous heuristic tuning process. Nevertheless, it is estimated that about 25% of the industrial process systems having PID control capability are eventually operated manually, due to the inability to tune the controls automatically. In addition, the fundamental application of a PID control system assumes a static set point, which does not work well to control systems with widely varying conditions.

Control in the field of mechanical testers is especially difficult since the process set point can be varied during operation, and the setpoint and control variable values can vary widely in a single experiment. This presents a significant obstacle for controlling the process, and the control strategies in this application area are frequently protected via trade secrets. In practice, each instrument is custom-tuned to operate optimally in a predetermined range of applications.

The fundamental problem with the PID type strategy is that it is a feedback system with several interacting mathematical calculations which provide a complex correction and damping function to the feedback signal. Further, the approach takes little advantage of knowledge of the controlled system, and relies on heuristic mathematical relationships.

The control of mechanical testers has long been a challenge for vendors and experimentalists. Control of crosshead speed essentially controls deformation rate, or strain rate; control of the experiment via rate of application of force provides stress rate. Crosshead speed has been the traditionally preferred measurement for practical reasons, namely cost and tradition. In mechanical testing, the problem lies in the fact that the resistance to motion changes significantly during an experiment, and the range of changes during a measurement experiment is very broad. The traditional control approach has been to use PID controllers tuned for specific types of samples and equipment. Tuning is done to find a workable balance between range of control and system instability for each instrument in a given application. For instrument vendors, this problem has been costly to address. In addition to an expensive motor and power supply, a tunable servo controller costing as much as the motor and the whole power supply may be required. Unfortunately, the results have been barely adequate, especially compared to the effort and expense to obtain them. To date, vendors have not commonly provided user programmable algorithmic controllers, presumably because of the cost to engineer a user friendly, completely programmable acquisition and control system.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### BRIEF SUMMARY OF THE INVENTION

One embodiment relates to a method of controlling a mechanical testing instrument. The method includes estimating a young's modulus, and applying force during a first time interval; comparing, after first interval, distance measured to expected distance; predicting a distance based on a first selected slope, at the end of a second period applying displacement distance and recalculating the slope; providing a corrected force to be applied for the proper displacement based on measured modulus and correction factor and adjusting into time and distance coherence; applying a force versus time regime interval and predict deformation at the end of the second interval measuring true deformation distance at the end of the second interval calculating the ‘true’ slope’ for sample predicting force based on the extrapolated actual slope; calculating a slope to apply for desired distance; and repeating measurement and correction steps, using the actual slope as the prediction basis.

Another embodiment relates to a control system for a mechanical testing instrument. The control system includes a data acquisition system having analog input channels and digital input channels, and an analog output channel and a digital output channel. An expansion board is connected in data communication with the data acquisition system. The expansion board includes interface circuitry for data acquisition and control of the mechanical testing instrument. The mechanical testing instrument is arranged to test a material strength and includes a load frame in which a material specimen is mounted. The load frame applies a mechanical load to the specimen. The data acquisitions system and the expansion board are connected in data communication with a processor. The processor is programmed to execute an algorithm to: estimate a Young's modulus, generate a force parameter to be applied by the mechanical instrument during a first time interval; receive a measured distance in response to the applied force; compare the distance measured to an expected distance based on the estimated Young's modulus; predict a distance based on a first selected slope representing the displacement of the mechanical test instrument in response to an applied force; at the end of a second time interval apply a displacement distance and recalculating the slope; determine a corrected force parameter to be applied for a predetermined displacement adjust the Young's modulus and the correction factor into coherence for time and distance; predict a deformation at the end of the second interval measuring true deformation distance at the end of the second interval; and calculate an actual slope calculating a slope to apply for desired distance.

A novel method and apparatus for control of mechanical tester systems is described below. An advantage of the disclosed method and apparatus is the avoidance of pitfalls inherent in P, PI, and PID control systems, primarily because the disclosed method is based on the measurement of real time system performance of the device to be controlled.

Certain advantages of the embodiments described herein include previously unavailable freedom from many limitations in the arena of mechanical testing.

Another advantage is the use of real time computational capabilities for noise removal using smoothing and phase shifting techniques.

A further advantage is smart control of a mechanical tester using a spreadsheet based program and algorithms.

Alternative exemplary embodiments relate to other features and combinations of features as may be generally recited in the claims.

### BRIEF DESCRIPTION OF THE DRAWINGS

The application will become more fully understood from the following detailed description, taken in conjunction with the accompanying figures, wherein like reference numerals refer to like elements, in which:

FIG. 1 shows a flow diagram of a method and apparatus for controlling a mechanical tester.

FIG. 2 shows a graph of Instantaneous Speed Noise at various speeds with no load for the exemplary mechanical testing system.

FIG. 3 shows a graph of Instantaneous Speed noise at different load levels and constant speed.

FIG. 4 shows an example of PID Oscillation and control.

FIG. 5 shows a graph with the corrected deformation slope.

FIG. 6 shows a graph indicating system stability and the effect of smoothing of the signal when using noise removal as the basis for control.

FIG. 6 shows the removal of regular signal fluctuations via phase shifting.

FIG. 7 shows the combined effect of the smoothing algorithm with the smoothing function.

FIG. 8 shows the combined effect of the smoothing algorithm with the smoothing function or algorithm.

FIG. 9 shows a graph illustrating smart control with a mechanical tester.

FIG. 10 is a flow diagram of an alternate embodiment for control of mechanical testers and other systems.

FIG. 11 is an exemplary embodiment for a high-resolution data acquisition system.

FIG. 12 is an exemplary control sheet showing an embodiment of a control algorithm.

### DETAILED DESCRIPTION OF THE INVENTION

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

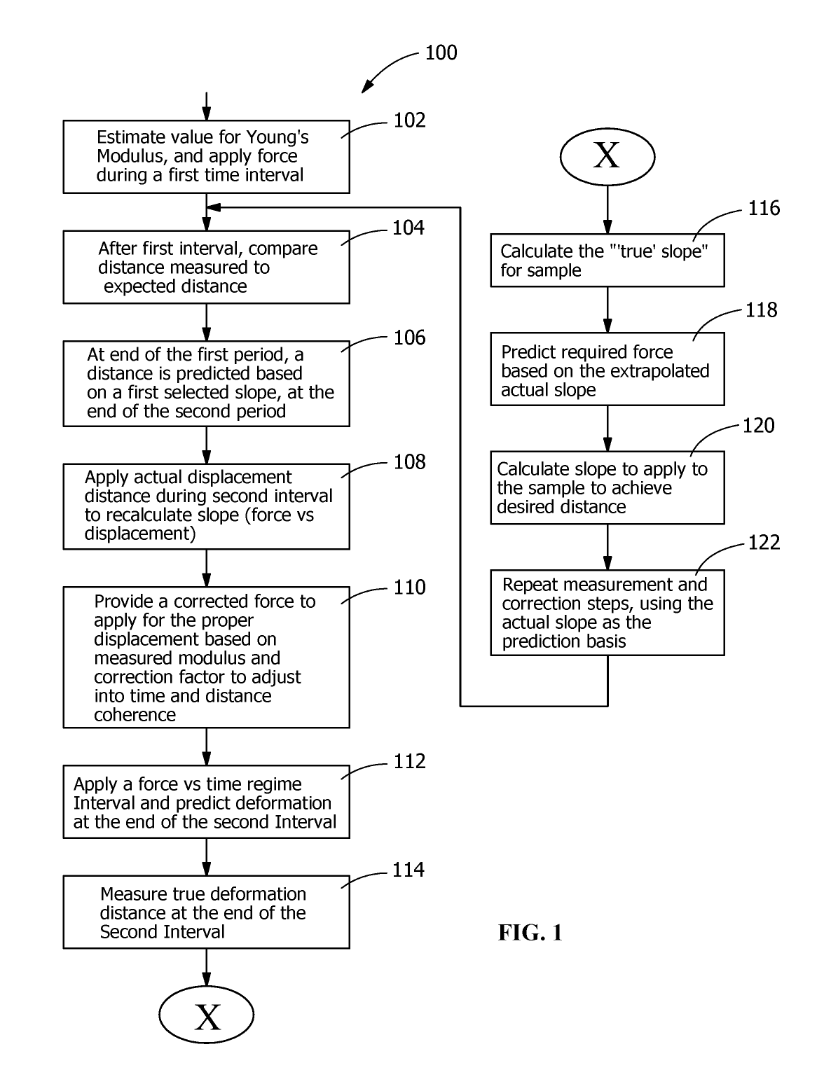

Referring to FIG. 1, a flow diagram 100 of a method and apparatus for controlling a mechanical tester is shown.

Disclosed is a multistep method or strategy. In the first step 102, an initial modulus of elasticity, or Young's Modulus, is assumed and a force applied during a first time interval. At the end of the first timed interval at step 104 the distance, e.g., crosshead travel, or sample deformation, etc.) is measured and compared to the distance expected, based on the assumed modulus. In the disclosed example a 5-unit time interval was used for illustration. The method then proceeds to further separate steps:

Referring to FIG. 1, at step 106, a first slope was selected, and, at the end of the first period, a distance was predicted to be achieved at the end of the second period.

Next, at step 108, the actual sample travelled only a 7.5 unit displacement distance during the second interval, rather than an expected displacement distance of 10. The measured data is used to calculate the real slope (force versus displacement) for the sample.

The method then proceeds to step 110, and a calculation is made to provide a corrected force to apply to the sample to achieve the proper displacement. The corrected force is based upon a combination of the measured modulus from step 102 and a correction factor to adjust the sample into time and distance coherence.

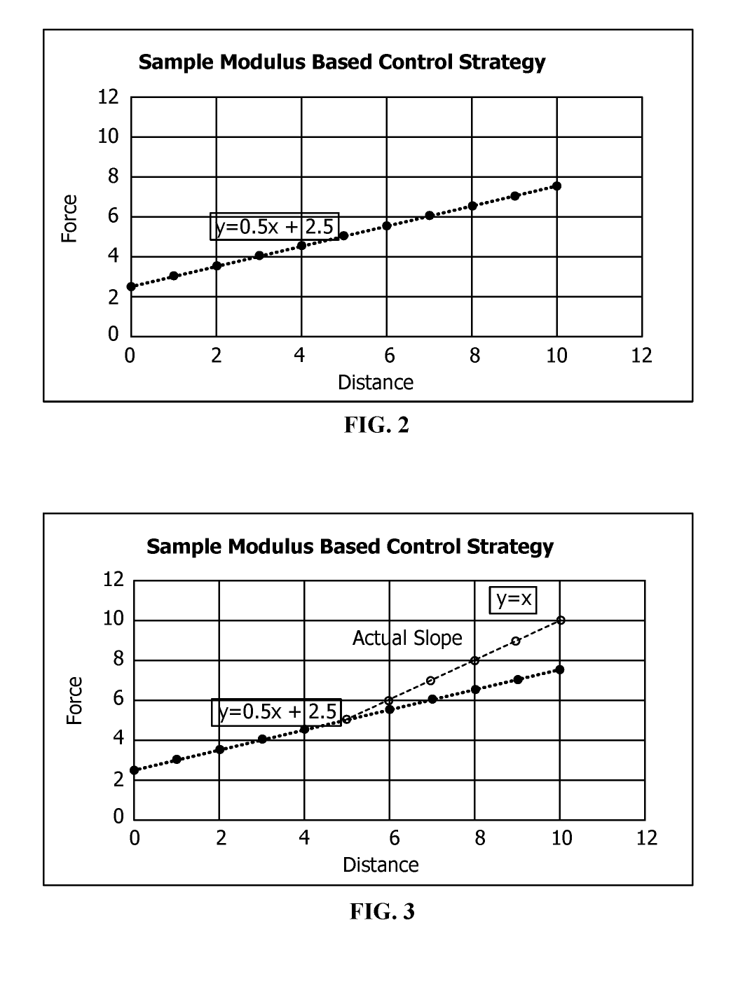

Next the method proceeds to step 112, to apply a force versus time regime, e.g., 0 to 5, at Interval 1, and predicts the deformation distance at the end of the second Interval, e.g., 5 to 10 time units. In FIG. 2 a graph is provided showing Instantaneous Speed Noise at various speeds with no load.

Then the method proceeds to step 114, to measure the true deformation distance at the end of the Second Interval (Time=10). FIG. 3 shows a graph of Instantaneous Speed noise at different load levels and constant speed.

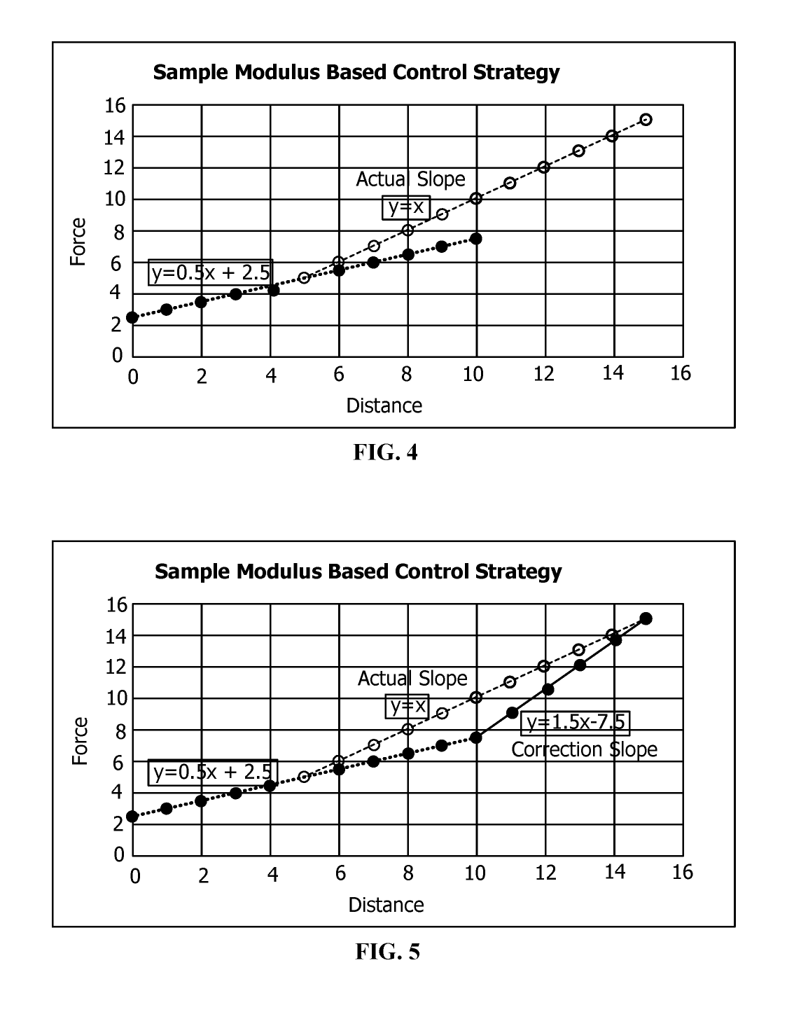

After measuring the true deformation distance, proceed to step 116 and calculate the true slope, i.e., force versus distance for the sample. FIG. 4 shows an example of PID Oscillation and control.

Next, at step 118, the method proceeds to predict the necessary force required to correct the deformation distance based on the extrapolated actual slope.

The method then proceeds at step 120 to calculate the slope necessary to apply to the sample to achieve that distance. FIG. 5 shows a graph with the corrected deformation slope.

At step 122, the method proceeds to repeat the measurement and correction steps using the actual slope as the prediction basis as provided in step 104. Optionally, steps may be included in the method to add fine adjustments. Control is based on the behavior of the sample, and uses an instrument-specific relationship of control voltage and resultant applied force.

Controlling a Mechanical Tester with Spreadsheet-Based Smart Control Algorithms

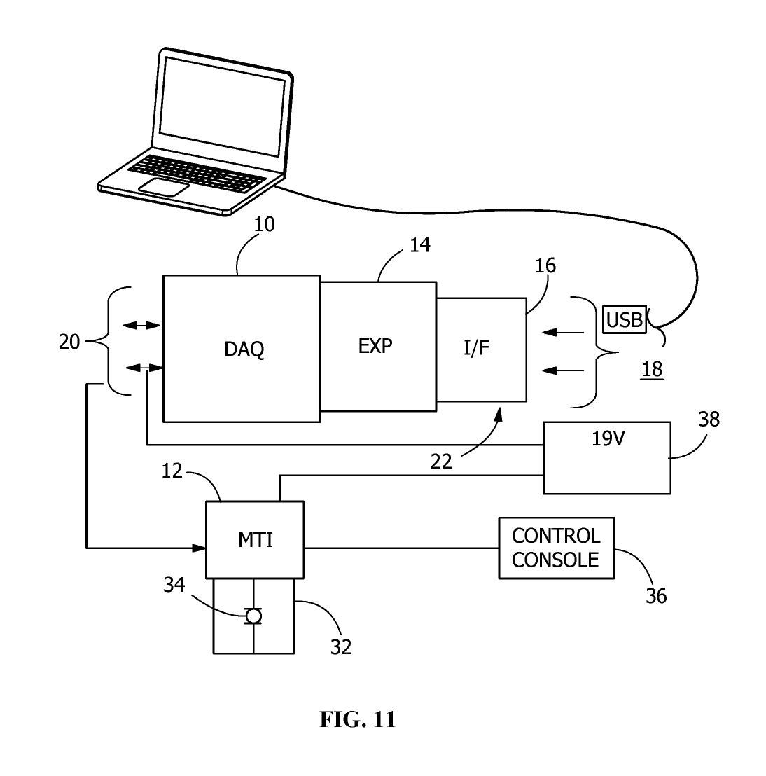

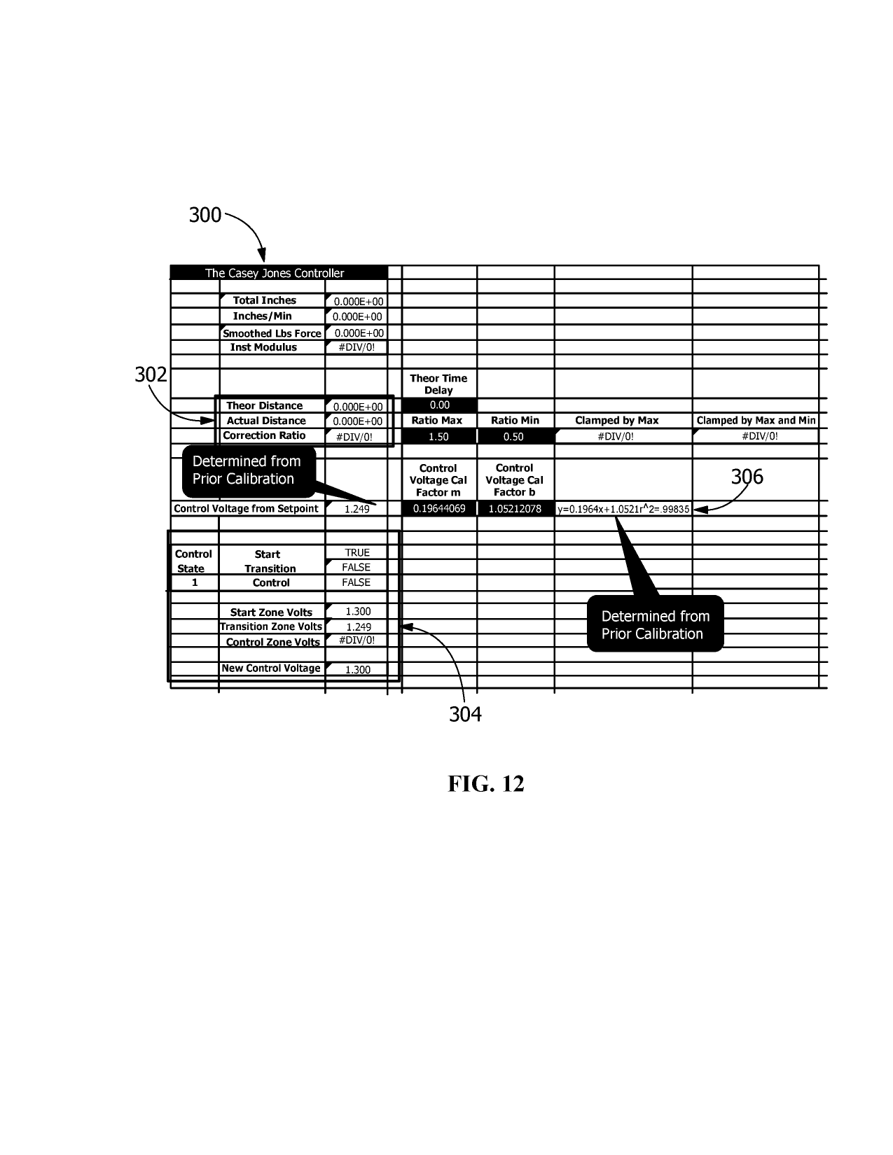

The use of a data acquisition system 10 (FIG. 11) and a smart control algorithm e.g., via a spreadsheet-based smart control algorithm, provides an improved instrument interface. The smart control algorithm may be programmed into, e.g., an Excel spreadsheet (FIG. 12) on a digital computer in data communication with the data acquisition system 10. Data acquisition system 10 provides instant high resolution of crosshead speed, force and distance measurements which can be applied for algorithmic motor control. These parameters provide freedom from many limitations in the prior mechanical testing systems. Studies have shown some control problems in mechanical testers and the advantage of the disclosed application of smart control to address those problems.

In one exemplary embodiment, careful measurement of the instantaneous crosshead speed reveals the mechanical resistance fluctuation in a typical unit. The mechanical resistance is cyclic and may present a significant problem, particularly at low rates of deformation or stress. Cycling causes the unit to stop and go at low speeds when used in a conventional prior art configuration. Cycling of the mechanical resistance is a significant source of instability when attempting to control the instrument. The figures below are self-explanatory.

These fluctuations significantly challenge controllers such as PID controllers on servo feedback setups to cover the range of system (sample and instrument) resistances during a single measurement experiment, minimize system instability, and yet provide fairly accurate speed control.

FIG. 4 shows an example of PID Oscillation and control.

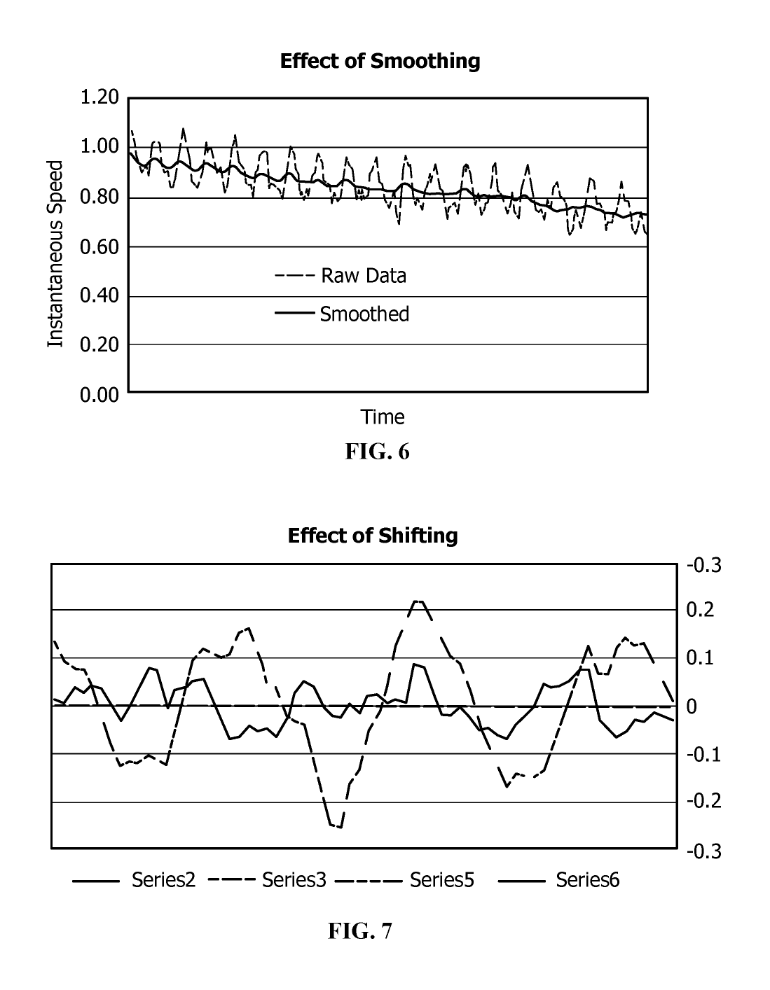

The data acquisition system 10 uses the real time computational capabilities to remove noise in different ways. Noise removal of the raw signals used as the basis for control provides great improvements in system stability and the effect of smoothing of the signal as shown in FIG. 6.

Referring next to FIG. 7, the removal of regular signal fluctuations via phase shifting provides an even more stable basis for a control algorithm. This process requires separating the signal into its short term and long term components, and treating these components separately, then recombining them. In one exemplary embodiment, an Excel spreadsheet algorithm may be used to accomplish phase shifting in real time. The effect of phase shifting results in substantial reduction in the temporal fluctuations without any significant increase in time constant.

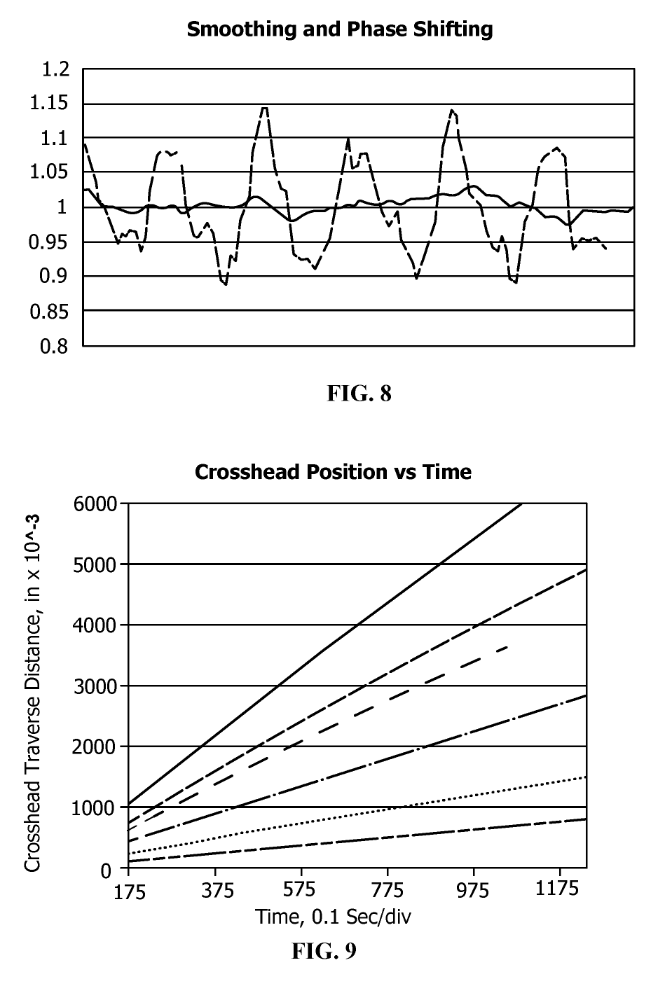

Referring next to FIG. 8, the smoothing algorithm is combined with a smoothing function, the result is improved even more. This provides a stable, but responsive signal basis for control. FIG. 8 shows the combined effect of the smoothing algorithm with the smoothing function.

The algorithms operating in real time provides improved control by greater than a factor of 10 in crosshead speed and a factor of 100 in mechanical resistance.

FIG. 9 shows a graph illustrating smart control with a mechanical tester.

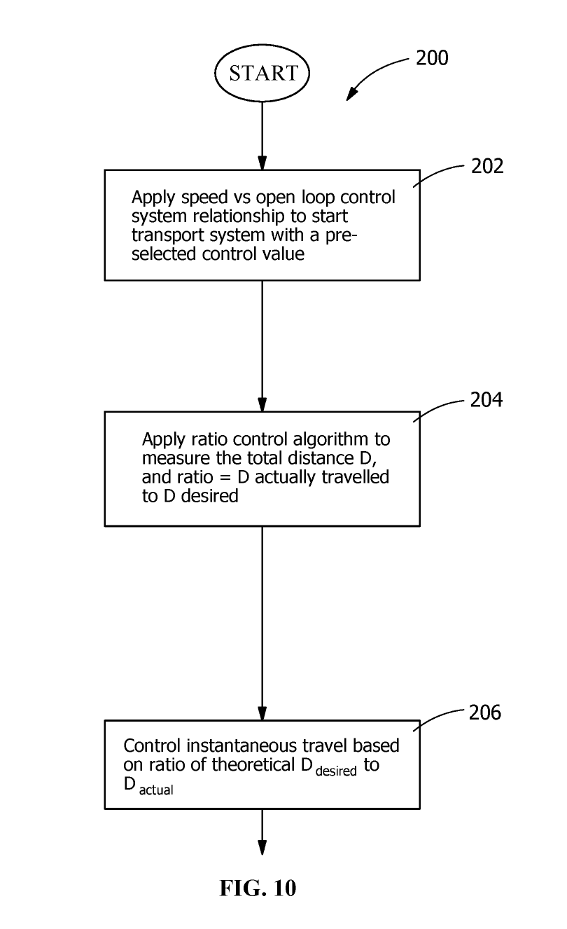

Referring next to FIG. 10, in another embodiment an improved control method 200 provides an improvement to traditional pulse-type encoders control for mechanical testers and other systems. A three step procedure is employed in a control method 200. The first step 202 employs a speed versus control system relationship to start the transport system. The control configuration is an open loop system with an intelligently selected open loop control value. The control method then proceeds to step 204, and applies a ratio control algorithm based on the total distance travelled, e.g, the integral of the pulse counter signal. The integral of the counter is a measure of the total distance travelled, and the control algorithm is based on the ratio of the distance actually travelled to the distance desired to have been travelled to that point. During this period, the method limits the range of ratio feedback control, and thus limits any propensity of the system to oscillate. In another embodiment the total distance travelled may be determined using alternate means, such as a string potentiometer or other distance measurement sensor. The method proceeds next to a third step 206, in which instantaneous travel is controlled based on a ratio of theoretical distance desired to have been travelled to the actual distance travelled. The above-described control method yields excellent results in practice within seconds.

Referring next to FIG. 11, in one embodiment a Delta-Sigma encoding high-resolution data acquisition system 10 for a Universal Serial Bus (USB) provides a general purpose analog-to-digital (A/D) converter or a built-in interface for the mechanical testing instrument 12. Multiple analog input channels may be provided, along with multiple analog outputs, multiple digital inputs and multiple digital outputs.

Optionally the data acquisition system 10 may incorporate optical isolation and input protection to allow the high resolution data acquisition system to function reliably, e.g., in an industrial environment.

In the exemplary embodiment the standard analog input range may be +/−5 volts, true differential with a maximum single-channel data rate of 1000 Hz at 20 bits effective resolution. Two or more channels may be scanned at 100 Hz with effective resolution of 20 bits. As the unit is slowed down, it quickly gains effective bits to 22 bits at 200 Hz and 22.5 at 50 Hz for single-channel operation. Visual Basic (VB) code may include real-time graphic presentation of data, and is suitable for general-purpose data logging applications. In the exemplary embodiment disclosed the data acquisition system provides a 24-bit delta-sigma converter with microcontroller supervisor and optical isolation. The programmable data rate may be, e.g., 50 to 1000 Hz, with lower rates generated through digital averaging.

The data acquisition system 10 includes an expansion board 14. Expansion board 14 has interfacing circuitry 16 suitable for acquisition and control applications. Inputs 18 may include voltage, current, frequency, or resistance, with accommodation for RTD, string pot or thermistor temperature sensors. Analog Outputs 20 may be voltage, current, or PWM. Optically isolated current outputs can accommodate 2 amps or greater, and digital outputs can accommodate up to 250 ma. It will be understood by persons skilled in the art that the analog output can be used to drive accessory current supplies with capabilities exceeding 300 watts.

Individual interfacing blocks are configured for use with 24-bit data acquisition systems. High impedance analog inputs interface directly to ion selective and pH electrodes. High resolution provides direct interfacing to bridge sensors or thermocouples.

Proportional drive circuits 22 included on the expansion board are optically isolated power drivers for solenoids, valves, DC heaters, DC motors, and other DC loads. A proportional current from 0 to 2.5 amperes or more is output. The current output follows an analog voltage from analog outputs on the data acquisition system.

A proportional valve, a fan motor, and a heating element (not shown) may be controlled with resolution matching the analog control voltage. The output capacity may be up to 2 amps, or more, at 10 to 24 volts, optically isolated, with an input control voltage range of 0-5 volts. An exemplary modulation frequency range is 1500 Hz or 4000 Hz, but may vary over a wide range. A Counts-to-Volts input is included with a frequency or pulse stream converted to a precise analog voltage. The input may be a pulse or frequency generator, including position sensors and radiation detectors. In an embodiment expansion board includes an 18-bit resolution, high stability counts-to-volts converter. Optical isolation is provided on the input. Multiple current sink outputs are provided, along with a PWM output.

Additional hardware components used in the exemplary embodiment may include a power supply, e.g., a 19 volt 4.7 amp DC power supply, a material testing instrument 30, e.g., an Instron® Mini 44, and a double-pole, double-throw (DPDT) relay rated, e.g., for 5 V DC and 15 amperes at 24 V_{DC}.

Materials testing instrument 12 is configured to test the strength of materials. One exemplary system is an Instron Series 4400 Universal Testing Instrument. Material testing instrument 12 has a load frame 32 in which a specimen 34 of a test material is mounted. Load frame 32 applies a tension or compression load to specimen 34, and a control console 36 that provides calibration, test setup, and test operating parameters. Control console 36 includes an operator's panel with controls that provide communications with the system through a numeric keypad, pushbutton selection switches and Liquid Crystal Displays (LCDs). Optionally, interfacing may be provided for an X-Y or a strip chart recorder, a printer, and a programmable computer.

A separate 19 V_{DC} supply 38 from data acquisition system 10 is connected to an analog output port 20 for material testing instrument 12. A motor in material testing instrument 12 is connected directly to a digital output port. A motor encoder output connects to counts on the data acquisition system expansion board. The DPDT relay is wired to switch polarity of the power output to material testing instrument motor and connected to a digital output.

Referring next to FIG. 12, an exemplary control spreadsheet 300 includes two areas highlighted by the callouts 302, 304, which show the use of the prior calibration information as described above.

The area in the cell box 302 is the basis of the control algorithm. The parameters in box 302 provide data points for the current cross arm position, and the desired location of the cross arm. The reciprocal of this calculation is the correction ratio and generates a signal to be applied to the existing control voltage.

Two clamping values are provided to prevent runaway control, e.g., should one of the signals not be accurately received. These are defined as minimum ration and maximum ratio values (Ratio Min and Ratio Max) shown in box 304.

Another section of the spreadsheet algorithm shown in box 306 is used by the control algorithm. Many physical systems, including but not limited to mechanical testing instruments, continue to operate at a lower control voltage than that at which they will start. Therefore, three zones of control are implemented in the control algorithm, including a start zone, a transition zone and a control zone, as described below:

Initially, in the start zone the control voltage applied to the mechanical testing instrument is set to an initial value determined from prior experimentation to begin the motor rotation or other desired movement. The start zone is normally a short period, e.g., about one second, to overcome the initial system inertia.

The transition zone is the next zone in the control algorithm that is applied once the system is started, and provides the intelligence which determines, based on the prior calibration information, the control voltage to be applied to achieve a travel rate that approaching the set-point speed before going into the steady-state control zone. The transition zone provides a smooth transition between the start and control zones. Next, the control zone implements the ratiometric control algorithm.

The distance travelled versus theoretical distance ratio for control provides a very stable control-improvement over PID control and eliminates the oscillatory tendency of PID control schemes. In another embodiment, the predictive element analog to the modulus measurement may be included to provide more precise and accurate control.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products on any machine-readable media for accomplishing its operations. The embodiments of the present application may be implemented using an existing computer processors, or by a special purpose computer processor for an appropriate system, incorporated for this or another purpose or by a hardwired system.

It is important to note that the construction and arrangement of the instrument interface system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium.

Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

1. A method of controlling a mechanical testing instrument comprising:
estimating a Young's modulus
applying a force during a first time interval;
comparing, a distance measured to an expected distance;
predicting a distance based on a first selected slope, the first selected slope representing the displacement of the mechanical test instrument in response to an applied force;
at the end of a second time interval applying a displacement distance and recalculating the slope;
determining a corrected force parameter to be applied for a predetermined displacement based on the measured Young's modulus and a correction factor;
adjusting the Young's modulus and the correction factor into coherence for time and distance; predicting a deformation at the end of the second interval measuring true deformation distance at the end of the second interval;
calculating an actual slope to apply for desired distance; and repeating measurement and correction steps, using the calculated actual slope as a prediction basis.

2. The method of claim 1, wherein the step of predicting at the end of the second interval comprises applying a force versus time regime interval.

3. The method of claim 1, wherein the step of calculating the actual slope comprises predicting force based on the extrapolated actual slope.

4. The method of claim 1, further comprising removing a regular signal fluctuation from a control signal via phase shifting to stabilize a control algorithm.

5. The method of claim 4, wherein the step of removing the regular signal fluctuation comprises separating the control signal into a short term component and a long term component, treating the short and long term components separately, and recombining the short and long term components.

6. The method of claim 5, further comprising using a spreadsheet algorithm to phase shift the signal to reduce temporal fluctuations.

7. The method of claim 6, further comprising applying a smoothing algorithm with a smoothing function to generate a stable signal basis for controlling the mechanical testing instrument.

8. A system for controlling a mechanical testing instrument comprising:
a data acquisition system including a plurality of analog input channels and digital input channels, at least one analog output channel and at least one digital output channel;
an expansion board in data communication with the data acquisition system, the expansion board comprising an interface circuitry for data acquisition and control of the mechanical testing instrument;
the mechanical testing instrument configured to test a material strength and having a load frame in which a specimen of the material is mounted, the load frame configured to apply a load to the specimen; the data acquisitions system and the expansion board in data communication with a processor; the processor configured to:
estimate a Young's modulus,
generate a force parameter to be applied by the mechanical instrument during a first time interval;
receive a measured distance in response to the applied force;
compare the distance measured to an expected distance based on the estimated Young's modulus;
predict a distance based on a first selected slope representing the displacement of the mechanical test instrument in response to an applied force;
at the end of a second time interval apply a displacement distance and recalculating the slope;
determine a corrected force parameter to be applied for a predetermined displacement adjust the Young's modulus and the correction factor into coherence for time and distance; predict a deformation at the end of the second interval measuring true deformation distance at the end of the second interval; and
calculate an actual slope calculating a slope to apply for desired distance.

9. The system of claim 8, wherein the corrected force parameter is calculated based upon the measured Young's modulus and a correction factor.

10. The system of claim 8, wherein the measured distance corresponds with a crosshead travel.

11. The system of claim 8, wherein the measured distance corresponds with a deformation of a mechanical test sample.

12. The system of claim 8, wherein the data acquisition system comprises an analog-to-digital (A/D) converter and an interface in data communication with the mechanical testing instrument;

13. The system of claim 8, wherein the processor being further configured to repeat the determination and correction steps, using the actual slope as the prediction basis.

14. The system of claim 8, wherein the analog input range for the analog input channel is +/−5 volts.

15. The system of claim 8, wherein the analog input channels being configured based on at least one of a voltage parameter, a current parameter, a frequency parameter, or a resistance parameter.

16. The system of claim 8, wherein the analog output channels are configured based on at least one of a voltage parameter, a current parameter, or a PWM signal.

17. The system of claim 8, further comprising a proportional drive circuit included on the expansion board, and power drivers for a DC motor, and a proportional current output.

18. The system of claim 17, further comprising a Counts-to-Volts input configured to convert a pulse stream to an analog voltage signal.

19. The system of claim 19, further comprising a spreadsheet programmed to process the I/O data for controlling the mechanical testing instrument.
